(19) United States
(12) Patent Application Publication
(10) Pub. No.: US 2007/0236907 A1
(43) Pub. Date: Oct. 11, 2007

(54) User interface devices and methods

(76) Inventors: Rick Latella, Woodstock, IL (US); Andy K. Baw, Wheeling, IL (US); Adam K. Cybart, McHenry, IL (US); Harold J. Gorenz, Lisle, IL (US); Paul R. Steuer, Hawthorn Woods, IL (US); Dave Fliszar, Gurnee, IL (US)

Correspondence Address: MOTOROLA INC, 600 NORTH US HIGHWAY 45, ROOM AS437, LIBERTYVILLE, IL, 60048-5343, US

(21) Appl. No.: 11/394,304

(22) Filed: Mar. 30, 2006

(51) Int. Cl. G01D 11/28

(52) U.S. Cl. 362/23; 362/84

(57) ABSTRACT

A user interface device of a wireless communication device in which one or more of the keys on the user interface are fluorescently illuminated when the user interface is in active mode. One or more keys may include a layer including an opaque film area and a non-opaque area, such as an aperture in the opaque film area in the shape of indicia, such as a number, letter or function indicator. The opaque film area blocks illumination, and the non-opaque area allows illumination to pass through it. Fluorescent ink at the non-opaque area of a key fluoresces when illuminated in active mode, providing fluorescent indicia viewable by a user.

### FIELD OF THE INVENTION

The present disclosure relates to a user interface of a wireless communication device, and more particularly to keys of a keypad that are configured for illumination of fluorescent ink forming indicia thereon and are configured for darkening due to a lack of fluorescent illumination.

### BACKGROUND OF THE INVENTION

The makers of wireless communication devices, including those of cellular telephones, are increasingly adding functionality to their devices. For example, cellular telephones include features such as music players, FM radios, including stereo audio capabilities, still and video cameras, video streaming and two-way video calling, email functionality, Internet browsers and organizers. Digital data from a PC or other source such as a network may be downloaded to the wireless communication device. The memory of a wireless communication device may be equivalent to, for example, an MP3 player. Therefore a wireless communication device may operate as an audio entertainment device in addition to providing communication functions. Cellular telephones in particular are becoming more than simply wireless communication devices. They are evolving into powerful tools for information management and entertainment.

As wireless communication devices become more integrated into the lives of users, the designers of the user interfaces have become more innovative regarding form, function and ergonomics. Accordingly, with the advent of multifunctional communication devices, usability benefits have become more important. Competition in the field of wireless communication devices also motivates designers to integrate appealing and differentiating features into user interfaces as well. For example, some communication devices use fluorescent ink for indicia on keys of their keypads to brighten the keypad display. Ambient UV illumination can add brightness to indicia on the keys.

It would be beneficial that a user interface combine appealing and differentiating features with usability benefits. In particular, for a sleek appearance that is different from other user interfaces, it would be beneficial if the keys on the user interface were illuminated and others hidden when the wireless communication device is in an active mode and darkened when in inactive mode. More particularly, it would be beneficial were certain keys illuminated when the wireless communication device is activated in different modes. Accordingly, it would be beneficial were there a manner in which to darken certain keys while illuminating other keys and preferably while maintaining visibility of illuminated keys in various ambient lighting conditions.

### BRIEF DESCRIPTION OF THE DRAWINGS

FIG. 1 shows a wireless communication device including a user interface and a block diagram of components of the wireless communication device;

FIG. 2 shows a side view of the wireless communication device of FIG. 1;

FIG. 3 shows a side view of layers of one key including a layer having an opaque film area and a non-opaque area;

FIG. 4 shows a top view of a layer of the key of FIG. 3 including an opaque film area and a non-opaque area; and

FIG. 5 is a flowchart illustrating an operation of switching at least one key of a plurality of keys of a keypad between a first state and a second state.

### DETAILED DESCRIPTION OF THE EMBODIMENTS

Described is a user interface device of a wireless communication device including a plurality of keys and a method of a plurality of keys of a user interface device. Also described is a single key. In referring to a plurality of keys, a single key is described as well. One or more of the keys on a user interface are illuminated when the keypad is in active mode or a first state.

The indicia of the keys are illuminated with fluorescently illuminated ink in active mode. Accordingly, at least one key is configured to change between a first state in which the indicia is visible due to fluorescent illumination and a second state in which the indicia is less visible due to a lack of fluorescent illumination. For a user interface having a sleek appearance, the indicia of one or more keys on a user interface are not illuminated during inactive mode. When not illuminated, a key is in a second state. For convenience, a first state may refer to an active mode and the second state may refer to an inactive mode.

At least one key of the plurality of keys may include a layer including an opaque film area and a non-opaque area. A non-opaque area may be an aperture, gap or opening in the opaque film area that may be in the shape of indicia such as a number, letter or function indicator. The opaque film area blocks light. The non-opaque area may act as a window that allows light to pass through it. Fluorescent ink is at the non-opaque area. The fluorescent ink fluoresces when illuminated in active mode, providing fluorescent indicia viewable by a user. The fluorescent ink may include one or more compounds may that provide variable visibility based on fluorescent and/or UV illumination.

In one embodiment, a subset of the plurality of keys may be illuminated depending upon the mode of operation of the wireless communication device. For example, when the device is operating as a communication device, then alphanumeric keys may be illuminated and other keys could be less visible. On the other hand, when the device is operating as a music player, the audio control keys may be illuminated and other keys may be less visible. Accordingly, in an inactive mode, keys are less visible due to a lack of fluorescent illumination. When less visible, darkened or hidden, the keys on the user interface may also be referred to as having a stealth keypad lighting effect.

The instant disclosure is provided to further explain in an enabling fashion the best modes of making and using various embodiments in accordance with the present invention. The disclosure is further offered to enhance an understanding and appreciation for the invention principles and advantages thereof, rather than to limit in any manner the invention. The invention is defined solely by the appended claims including any amendments of this application and all equivalents of those claims as issued.

It is further understood that the use of relational terms, if any, such as first and second, top and bottom, and the like are used solely to distinguish one from another entity or action without necessarily requiring or implying any actual such relationship or order between such entities or actions. The terms, first state and second state, may be used interchangeably. Much of the inventive functionality and many of the inventive principles are best implemented with or in software programs or instructions and integrated circuits (ICs) such as application specific ICs. It is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation. Therefore, in the interest of brevity and minimization of any risk of obscuring the principles and concepts according to the present invention, further discussion of such software and ICs, if any, will be limited to the essentials with respect to the principles and concepts within the embodiments.

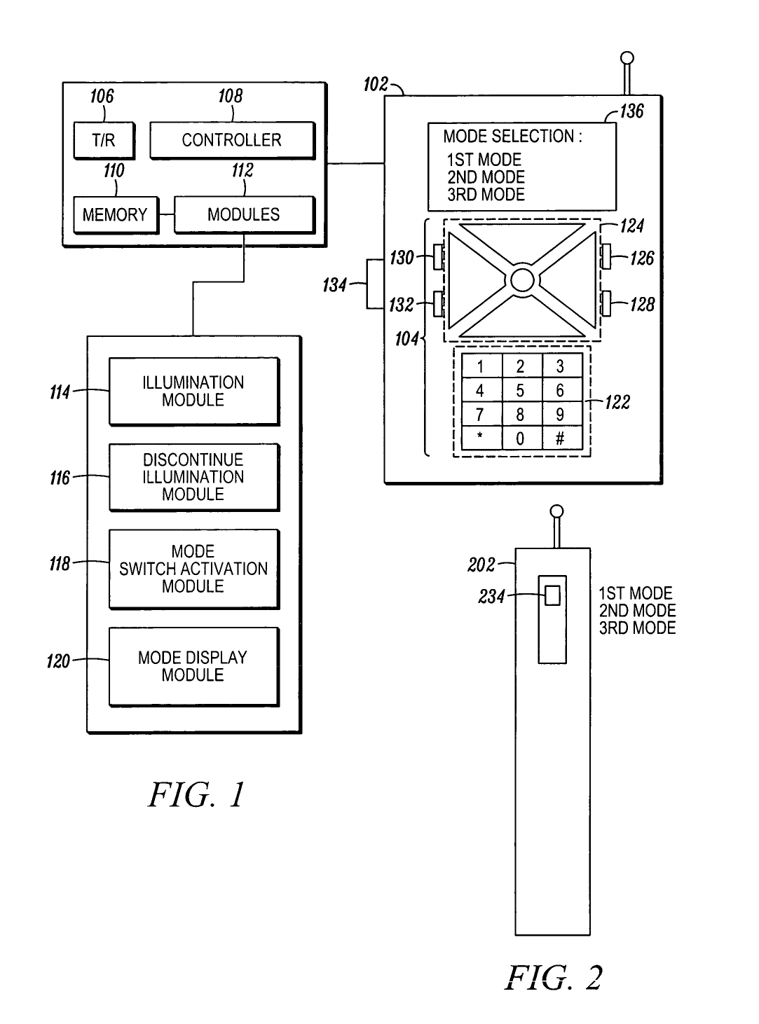

FIG. 1 shows a wireless communication device including a user interface and a block diagram of components of the wireless communication device. The wireless communication device 102 may be implemented as a cellular telephone (also called a mobile phone). The wireless communication device 102 represents a wide variety of devices that have been developed for use within various networks. Such handheld communication devices include, for example, cellular telephones, messaging devices, personal digital assistants (PDAs), notebook or laptop computers incorporating communication modems, mobile data terminals, application specific gaming devices, video gaming devices incorporating wireless modems, and the like. Any of these portable devices may be referred to as a mobile station or user equipment. Herein, wireless communication technologies may include, for example, voice communication, the capability of transferring digital data, SMS messaging, Internet access, multi-media content access and/or voice over internet protocol (VoIP).

The keypad 104 assembly of the user interface of the wireless communication device 102 may be of any configuration. It is understood that the keypad illustrated in FIG. 1 is illustrative. The keypad may contain a plurality of keys. The construction of the keypad may be of any type that suitably provides the first state of fluorescent illumination of the indicia and the second state of darkening of the indicia as described herein. The keys may be capable of depression and tactile feedback. Key feedback mechanisms may include for example, poppels.

The optical phenomenon of fluorescence is a luminescence in which a molecule absorbs a high-energy photon and re-emits it as a lower-energy photon of a longer wavelength. Vibrations or heat result from the energy difference in the absorbed and emitted photons. Depending upon the absorbance curve and Stokes shift of the particular fluorophore, typically the absorbed photon is in the ultraviolet and the emitted light is in the visible range. The term fluorescence comes from mineral fluorite, composed of calcium fluoride that displays this phenomenon.

The wireless communication device 102 may include a transceiver 106, controller 108 and memory 110 including modules 112. One or more transceivers may provide, for example cellular communication, Bluetooth communication and WIFI communication. As a music player, the wireless communication device may, for example, receive audio downloads via the transceiver 106. The controller 108 may receive instructions for activating the states of the keys depending upon the selected modes. The instructions may be maintained in the memory 110 and may be further stored in modules 112.

The modules may carry out certain processes of the methods and functions as described herein. The modules may be implemented in software, such as in the form of one or more sets of prestored instructions, and/or hardware, which may facilitate the operation of the wireless communication device, mobile station or electronic device as discussed below. The modules may be installed at the factory or may be installed after distribution by, for example, a downloading operation. The modules may include an illumination module for illuminating a module in active mode 114, a discontinuation module for discontinuing illumination in inactive mode 116, a mode switching activation module 118 and a mode display module 120. The operations in accordance with the modules will be discussed in more detail below.

The keypad 104 may include a plurality of keys. All or a subset of the plurality of keys may be in active mode or inactive mode simultaneously. When all of the plurality of keys of the keypad are in inactive mode, the keypad may be darkened or stealth. That is, the indicia on the keys may be less visible, hidden or darkened. On the other hand, a subset of the keys may provide the user operation of a particular function of the wireless communication device 102.

A subset of the plurality of keys may be illuminated depending upon the mode of operation of the wireless communication device 102. Accordingly, for example, when the device is operating as a communication device, then alphanumeric keys 122 may be in the first state and therefore illuminated, and other keys could be less visible. On the other hand, when the device is operating as a music player, the audio control keys 124 may be in the first state and therefore may be illuminated, and other keys may be less visible. Accordingly, the visible keys may be in the first state. Moreover, the keys that are less visible may be in the second state. Other keys 126, 128, 130 and 132 may be configured for example, to operate particular functions of the wireless communication device 102. Modes may be changed by a switch or mode key 134 that is separate from the plurality of keys of the key pad. In addition or alternatively, the mode selection may be displayed on the display device 136 and navigated by the keys on the keypad. Any manner in which to alternate modes is within the scope of this discussion.

It is understood that the keys of the keypad 104 may be grouped together to form subsets of the plurality of keys in any manner. Moreover, it is understood that the wireless communication device may be in more than one mode simultaneously. It is further understood that the modes of the wireless communication device 102 are not limited to the modes discussed herein.

FIG. 2 shows a side view of the wireless communication device 202 of FIG. 1. The switch or mode key shown in FIG. 1 as 134 is shown in FIG. 2 as 234. The switch may be used to change modes. Activating the switch 234 which is separate from the plurality of keys, or a function key of the plurality of keys of the keypad, may change a subset of the plurality of keys between the first state and the second state. Any manner in which to change states or modes is within the scope of this discussion.

The usability benefits to the user of the illumination of particular keys may be that they are operable with respect to a particular mode without the distraction of other keys. In an active mode, the indicia of a key may be illuminated while those in an inactive mode are less visible. To make this effect, one or more keys of the keypad may include a layer including an opaque film area and a non-opaque area. A non-opaque area may be an aperture, gap or opening in the opaque film area that may be in the shape of indicia such as a number, letter or function indicator. The opaque film area blocks light. The non-opaque area may act as a window that allows light to pass through it. Fluorescent ink is at the non-opaque area. The fluorescent ink fluoresces when illuminated in active mode, providing fluorescent indicia viewable by a user. In inactive mode, colors and other characteristics of the layers may make the indicia less visible, darkened or hidden and may provide a stealth keypad lighting effect.

Briefly returning to FIG. 1, the entire keypad 104 may be composed of a plurality of layers of film, each being the size of the entire keypad. Alternatively, one or more keys, for example function keys 126, 128, 130 and 132 may be constructed of layers of film that may be the size of the key or sections of the keypad. Portions of the keypad 104, for example quarters, may be separate layers. The processes for constructing the keypad assembly are beyond the scope of this discussion. The layers that provide the selective fluorescent illumination of indicia of one or more keys are described in detail below.

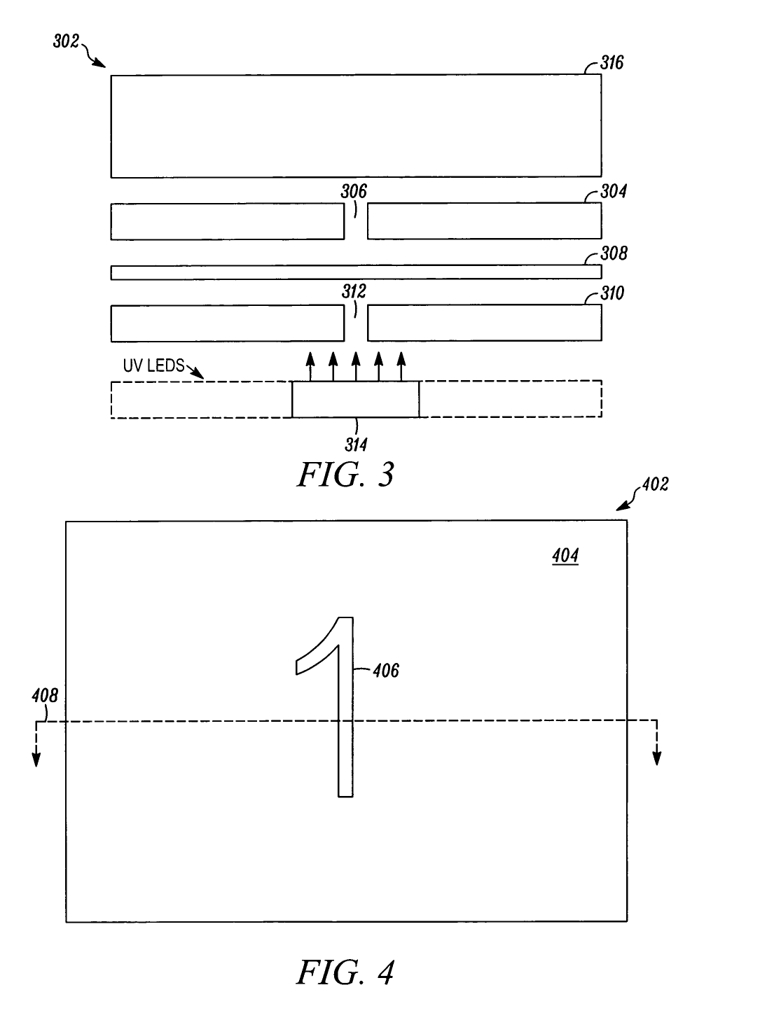

FIG. 3 shows a side view of layers of one key 302 including a layer having an opaque film area 304 and a non-opaque area 306. FIG. 4 shows a top view of one layer having a cross mark to indicate where the side view of FIG. 3 is taken. The opaque film area 304 blocks light. The non-opaque area 306 allows light to pass through it. A film including fluorescent ink 308 at the non-opaque area 306 of a key fluoresces when illuminated in active mode. Another film layer of an opaque ink 310 is shown including an aperture, hole or gap 312 through which light may pass. The opaque film, for example may be white to enhance the opaqueness of a dark layer 304 and to reflect light. A light source 314 is depicted. A protective layer 316 such as a clear polycarbonate film layer is also shown.

A light source 314 may include a white light LED to internally illuminate the keypad characters. White light may contain traces of ultraviolet light so the brightness of the keypad may be enhanced in dim and dark external lighting conditions. UV LEDs may be used in place of the white LEDs to further enhance the brightness of this effect. It is understood, that any suitable lighting components may be used in the described wireless communication device.

The fluorescent ink of film 308 may form indicia at the non-opaque area 306 when the fluorescent ink is illuminated by, for example, the light source 314. In generating fluorescent illumination the key may have a first state in which the indicia may be visible due to the fluorescent illumination. When fluorescent illumination is not generated, the key may have a second state in which the indicia may be less visible due to lack of fluorescent illumination.

As shown, the light source 314 provides illumination from behind, below or beneath a key 302. That is, the light may be projected in a direction from the light source 314 through areas 312 and 316 to illuminate the fluorescent ink of film 308. A user may therefore view indicia on the keypad.

As mentioned, light source 314 may be any suitable lighting component including those producing EL and/or UV light. Furthermore, there may be a combination of different types of light used as the backlight 314. Accordingly, a subset or subsets of all of the key characters/features may be illuminated, depending upon the use mode desired. For example, a use mode may be a telephone mode, an imaging mode or a music mode. Subsets of the keys may therefore be illuminated by powering a corresponding subset of internal lamps, for example, LEDs and a segmented EL. Additionally, variations of types of illumination sources may be used. For example, combinations of side firing LEDs be may powered so that the same feature is illuminated in a different manner depending upon the desired mode.

FIG. 4 shows a top view of the layer 402 of the key of FIG. 3 including an opaque film area 404 and a non-opaque area 406. The horizontal line 408 represents a slice through which the side view of FIG. 3 may be taken. Accordingly, the non-opaque area 406 of layer 402 may be in the shape of indicia. In other words, the opaque film area 404 and the non-opaque area 406 of layer 402 may form a stencil. A film including fluorescent ink (308, see FIG. 3) at the non-opaque area 406 may form indicia when placed above or below the layer 402. The light source (314, of FIG. 3) may cause fluorescent ink to fluoresce when illuminated in active mode. To the user, fluorescing indicia may be visible in active mode.

A translucent ink may include the fluorescent ink. Further more, a tinted transparent film (308, see FIG. 3) may include the translucent ink. The fluorescent ink may include one or more compounds that may provide variable visibility based on fluorescent illumination. Fluorescent ink may be applied to the layer 402 to form a film or layer (308, see FIG. 3). Alternatively, a combination of compounds may be molded or formed into a transparent film with other resin materials such as silicone, polyurethane or plastic and then positioned within the keypad assembly.

The translucent ink may include other illumination enhancing compounds such as at least one fluorescing compound sensitive to ultraviolet light. Additionally, the translucent ink or tinted transparent film may be partially reflective. Accordingly, when the sunlight may reach the indicia of a film including fluorescing and UV sensitive compounds of the key from outside the key, the internal lighting may pass through the indicia from inside the wireless communication device, the indicia may become brighter. A partially reflective film may also contribute to brightness in the sunlight. As mentioned above, the device's lighting source (314, see FIG. 3) may provide UV light as well.

As mentioned above, darkening one or more keys of the keypad so that it is less visible due to lack of fluorescent illumination may provide a sleek stealth keypad effect. In addition to discontinuing illumination of a key, darkening a key may be effected by the choice of colors used in the layers, particularly, the layer including an opaque film area and a non-opaque area (304, see FIG. 3) and the film including fluorescent ink (308, see FIG. 3). The user interface device may be further darkened if the opaque film area and the translucent ink of the fluorescent film include similar colors. The tint of the translucent ink may be of shading similar to sunglasses, semi-metalization and/or a combination of both. Either or both may be formulated to darken, hide or diffuse the image of the keypad indicia or characters. For example, a slate gray or black opaque film may be matched with a slate grey translucent ink. It is understood that while certain colors have been mentioned, any suitable colors may be used. Moreover, certain keys of the keypad may be of different colors than others. The background layer 304 may also be more than one color.

The contrast between the opaque film area and the fluorescent ink may be a low contrast. The opaque file area may have a particular tint. The tint of the opaque film area of layer (304, see FIG. 3) and the contrast of the translucent ink of the keypad fluorescent indicia may be optimally adjusted and matched to provide a trade-off between hiding the characters and allowing the characters to be visible during internal lighting in all environmental cases, for example, night, indoor and outdoor sunlight. For example, light gray indicia or characters may provide a low contrast with a dark or graphite gray background layer (304, see FIG. 3). Accordingly, indicia may be less visible when the fluorescent illumination is discontinued.

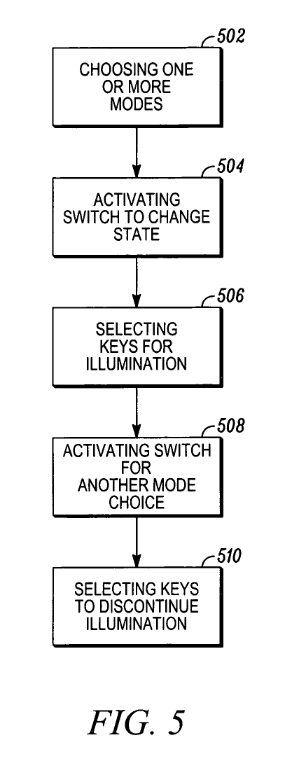

FIG. 5 is a flowchart illustrating an operation of switching at least one key of a plurality of keys of a keypad between a first state and a second state. As discussed above the keys of the keypad may be divided into subsets of keys that correspond to modes of the wireless communication device. For example, the wireless communication device may have a communication mode and music player mode. Other modes may include, for example, camera and/or video camera mode, radio mode, television mode, and video playback mode. The wireless communication device may be referred to as a morphing device, in that it changes its functionality depending upon selected modes. It is understood that any modes and combinations of modes are within the scope of this discussion.

A user or other entity may choose one or more modes 502. A switch (134, see FIG. 1) or navigable display (136, see FIG. 1) may provide a manner in which to chose a mode for the wireless communication device. For example, a mode display module (120, see FIG. 1) may provide instructions to effect the mode choice. Selecting the first state for a subset of the plurality of keys which may represent one or more modes of the communication device may be effected by activating a switch 504 or a set of instructions to change a subset of the plurality of keys of the keypad from an inactive state, above referred to as a second state, to an active state, a first state. A mode switching activation module (118, see FIG. 1) may provide instructions to activate a switch 504 or any other suitable device or operation to process the mode selection.

The keys corresponding to the mode, for example, a subset of the plurality of keys of the keypad, once selected, may be illuminated 506 as described in detail above. An illumination module for illuminating a module in active mode (114, see FIG. 1) may provide instructions to illuminate the keys corresponding to a selected mode. Another mode choice may be made by the user or other entity 508. Accordingly, keys may be selected so as to discontinue their illumination 510. A discontinuation module for discontinuing illumination in inactive mode (116, see FIG. 1) may provide instruction for changing states between the second state and the first state, or active mode to inactive mode.

While the operation of different modes has been discussed in detail, it is understood that the entire keypad of fluorescently lighted keys and alternatively darkened keys that are less visible due to a lack of fluorescent illumination may operate simultaneously. Moreover, a portion of the keypad may include keys with the described dual state operations. The plurality of keys may include a layer including an opaque film area and a non-opaque area such as an aperture in the opaque film area in the shape of indicia such as a number, letter or function indicator so that the opaque film area blocks light and so that the non-opaque area allows light to pass through it. Fluorescent ink at the non-opaque area of a key fluoresces when illuminated in active mode, providing fluorescent indicia viewable by the user.

This disclosure is intended to explain how to fashion and use various embodiments in accordance with the technology rather than to limit the true, intended, and fair scope and spirit thereof. The foregoing description is not intended to be exhaustive or to be limited to the precise forms disclosed. Modifications or variations are possible in light of the above teachings. The embodiment(s) was chosen and described to provide the best illustration of the principle of the described technology and its practical application, and to enable one of ordinary skill in the art to utilize the technology in various embodiments and with various modifications as are suited to the particular use contemplated. All such modifications and variations are within the scope of the invention as determined by the appended claims, as may be amended during the pendency of this application for patent, and all equivalents thereof, when interpreted in accordance with the breadth to which they are fairly, legally and equitable entitled.

1. A user interface device of a wireless communication device, comprising:
a plurality of keys; and
at least one key of the plurality of keys comprising a layer including an opaque film area and a non-opaque area, the at least one key including indicia at a non-opaque area having a fluorescent ink,
wherein the at least one key is configured to change between a first state in which the indicia is visible due to fluorescent illumination and a second state in which the indicia is less visible due to a lack of fluorescent illumination.

2. The user interface device of claim 1, wherein the fluorescent ink comprises variable visibility based on fluorescent illumination.

3. The user interface device of claim 1, further comprising:
a translucent ink comprising the fluorescent ink.

4. The user interface device of claim 3, wherein the translucent ink further comprises at least one fluorescing compound sensitive to ultraviolet light.

5. The user interface device of claim 3, further comprising:
a tinted transparent film comprising the translucent ink.

6. The user interface device of claim 3, wherein the opaque film area of the layer and the translucent ink comprise similar colors.

7. The user interface device of claim 1, further comprising:
a backlight illumination source of the key of the device for illuminating the fluorescent ink in the first state.

8. The user interface device of claim 1, further comprising:
a contrast between the opaque film area and the fluorescent ink;
wherein the contrast between the opaque film area and the fluorescent ink is a low contrast.

9. The user interface device of claim 1, wherein the plurality of keys are capable of depression and tactile feedback.

10. The user interface device of claim 1, further comprising:
a mode switch configured to change a subset of the plurality of keys from the first state to the second state.

11. The user interface device of claim 1, further comprising:
a display device configured to display a menu to change a subset of the plurality of keys from the first state to the second state.

12. A key of a plurality of keys of a user interface device, comprising:
a layer including an opaque film area and a non-opaque area; and
fluorescent ink forming indicia at the non-opaque area when the fluorescent ink is illuminated,
wherein the key has a first state in which the indicia is visible due to fluorescent illumination and a second state in which the indicia is less visible due to a lack of fluorescent illumination.

13. The key of claim 12, further comprising:
a contrast between the opaque film area and the fluorescent ink,
wherein the contrast between the opaque film area and the fluorescent ink is a low contrast.

14. The key of claim 12, further comprising:
a translucent ink comprising the fluorescent ink.

15. The key of claim 14, further comprising:
a tinted transparent film comprising the translucent ink wherein the translucent ink further comprises at least one fluorescing compound sensitive to ultraviolet light.

16. The key of claim 14, wherein the opaque film area and the translucent ink comprise similar colors.

17. The key of claim 12, further comprising:
a backlight illumination source of the key of the device for illuminating the fluorescent ink.

18. The key of claim 12, wherein the key is capable of depression and tactile feedback.

19. A method of a plurality of keys of a user interface device, the plurality of keys having a layer comprising an opaque film area and a non-opaque area, wherein fluorescent ink at the non-opaque area forms indicia when illuminated, the method comprising:
illuminating the fluorescent ink on at least one of the plurality of keys so that the key is in a first state;
discontinuing the illumination of the fluorescent ink so that the key is in a second state; and
changing the key from the second state to the first state.

20. The method of claim 19, wherein at least one of a subset of the plurality of keys provides a mode of operation, the method further comprising:
selecting the first state for a subset of the plurality of keys; and
illuminating the fluorescent ink of the subset of the plurality of keys.

21. The method of claim 19, wherein at least one of a subset of the plurality of keys provides a mode of operation, the method further comprising:
displaying on a display device configured to display indicia to change a subset of the keys of the plurality of keys from the first state to the second state.

22. The method of claim 19, wherein at least one of a subset of the plurality of keys provides a mode of operation, the method further comprising:
activating a switch separate from the plurality of keys to change a subset of the plurality of keys between the first state and the second state.

23. The method of claim 19, wherein illuminating the fluorescent ink on at least one of the plurality of keys, comprises:
powering a backlight illumination source of the key of the device.
